(19) United States
(12) Patent Application Publication
(10) Pub. No.: US 2003/0126716 A1
(43) Pub. Date: Jul. 10, 2003

(54) Door closer with a reliable arresting effect

(76) Inventor: Percy Lin, Dou-Liu City (TW)

Correspondence Address: LARSON & TAYLOR, PLC, 1199 NORTH FAIRFAX STREET, SUITE 900, ALEXANDRIA, VA, 22314, US

(21) Appl. No.: 10/073,227

(22) Filed: Feb. 13, 2002

(30) Foreign Application Priority Data
Jan. 9, 2002 (TW) 91,200,176

(51) Int. Cl. E05F 3/00

(52) U.S. Cl. 16/66

(57) ABSTRACT

A door closer comprises a cylinder and a piston rod mounted in the cylinder and has an exposed section outside the cylinder. A retainer plate, an elastic element, a switch rod, and an end cap are mounted around the exposed section. The retainer plate has an arrestor. The elastic element has a first end attached to the cylinder and a second end attached to a side of the retainer plate. The switch rod includes a first side in contact with the other side of the retainer plate. The end cap is attached to a second side of the switch rod for enclosing the switch rod and the retainer plate. The end cap includes two longitudinal slots through which the retainer rod and the arrestor of the retainer plate extend outward such that the retainer rod and the arrestor of the retainer plate are rectilinearly movable along the longitudinal slots.

### BACKGROUND OF THE INVENTION

1. Field of the Invention

The present invention relates to a door closer with a reliable arresting effect. In particular, the present invention relates to a door closer that may reliably arrest the door in a desired position.

2. Description of the Related Art

FIGS. 1 and 2 of the drawings illustrate a conventional door closer comprising a cylinder 1′ having holes 10′ in an end thereof. Fasteners 101′ extend through the holes 10′ to fix the end of the cylinder 1′ to a doorframe. A piston rod 2′ is mounted in the cylinder 1′ and includes an end extending beyond the other end of the cylinder 1′. A retainer plate 3′ is mounted around an exposed section 21′ of the piston rod 2′. The exposed section 21′ of the piston rod 2′ includes a hole 210′. A fastener 211′ extends through the hole 210′ of the piston rod 2′ to fix the end of the piston rod 2′ to a door. The length of the exposed section 21′ in the closed state of the door is longer than that in the open state of the door. A compression spring 11′ mounted in the cylinder 1′ is compressed when the door is opened, and the spring force of the compression spring 11′ automatically closes the door when the force for opening the door vanishes. In a case that the door is to be retained in a desired open position so that the door would not be closed automatically, the retainer plate 3′ includes an arrestor 31′ for selectively pressing against a peripheral edge 12′ of the other end of the cylinder 1′. Thus, movement of the piston rod 2′ is stopped by an inner periphery 301′ defining a central hole 30′ of the retainer plate 31′. When automatic closing of the door is required again, the retainer plate 3′ is moved to disengage the arrestor 31′ from the peripheral edge 12′ of the cylinder 2′. When the force for opening the door vanishes, the returning force provided by the compression spring 11′ closes the door automatically. However, since the retainer plate 3′ is slidably mounted around the exposed section 21′ of the piston rod 2′, the retainer plate 3′ is apt to be shifted and thus fails to reliably arrest the door. In addition, the retainer plate 3′ is exposed outside the cylinder 1′ and thus not shielded, the user could be injured.

### SUMMARY OF THE INVENTION

An object of the present invention is to provide a door closer with a reliable arresting effect to reliably, precisely arrest the door in a desired open position. In addition, a retainer plate for achieving the reliable arresting effect is enclosed and thus avoids injury to the user.

A door closer in accordance with the present invention comprises a cylinder having an end and a piston rod mounted in the cylinder and having an end extending beyond the end of the cylinder. The piston rod has an exposed section outside the cylinder. A retainer plate is mounted around the exposed section of the piston rod, the retainer plate including an arrestor projecting therefrom. An elastic element is mounted around the exposed section of the piston rod and includes a first end attached to the end of the cylinder and a second end attached to a side of the retainer plate. A switch rod is mounted around the exposed section of the piston rod and includes a first side in contact with another side of the retainer plate. An end cap is mounted around the exposed section of the piston rod and attached to a second side of the switch rod for enclosing the switch rod and the retainer plate. The end cap includes two longitudinal slots through which the retainer rod and the arrestor of the retainer plate extend outward such that the retainer rod and the arrestor of the retainer plate are rectilinearly movable along the longitudinal slots.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view, partly exploded, of a conventional door closer.

FIG. 2 is a partial sectional view of the conventional door closer.

FIG. 3 is a perspective view, partly exploded, of a door closer in accordance with the present invention.

FIG. 4 is a partial sectional view of the door closer in accordance with the present invention.

FIG. 5 is a view similar to FIG. 4, illustrating operation for arresting the door in a desired position.

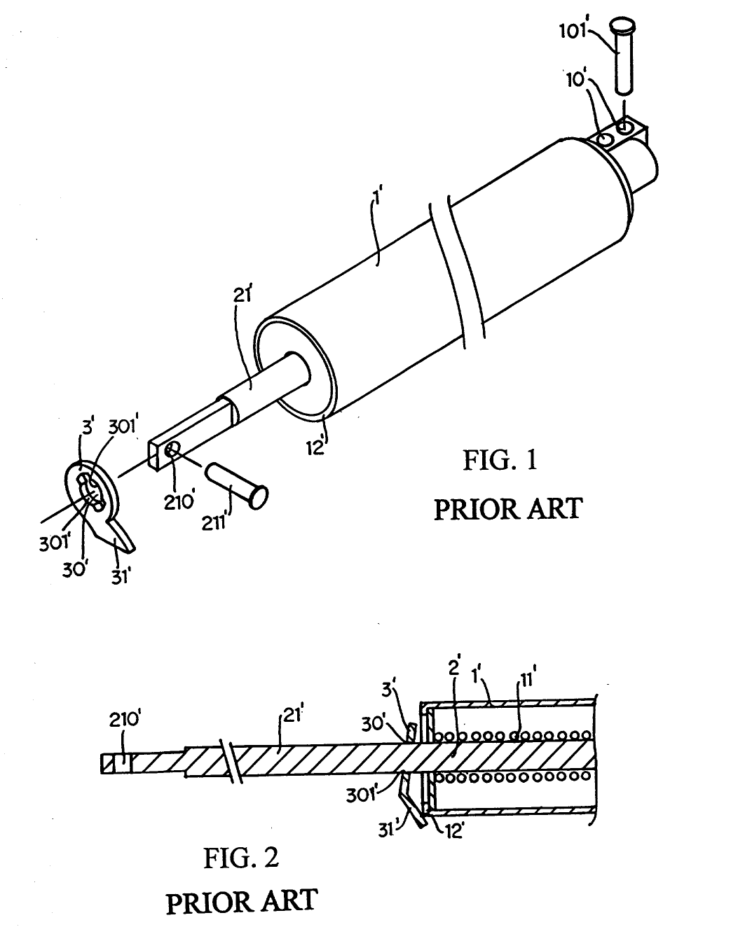

### DETAILED DESCRIPTION OF THE PREFERRED EMBODIMENT

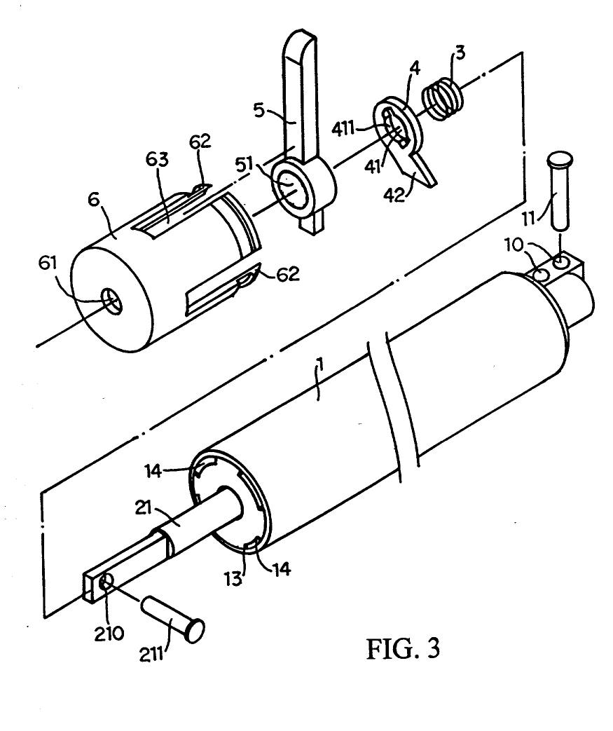

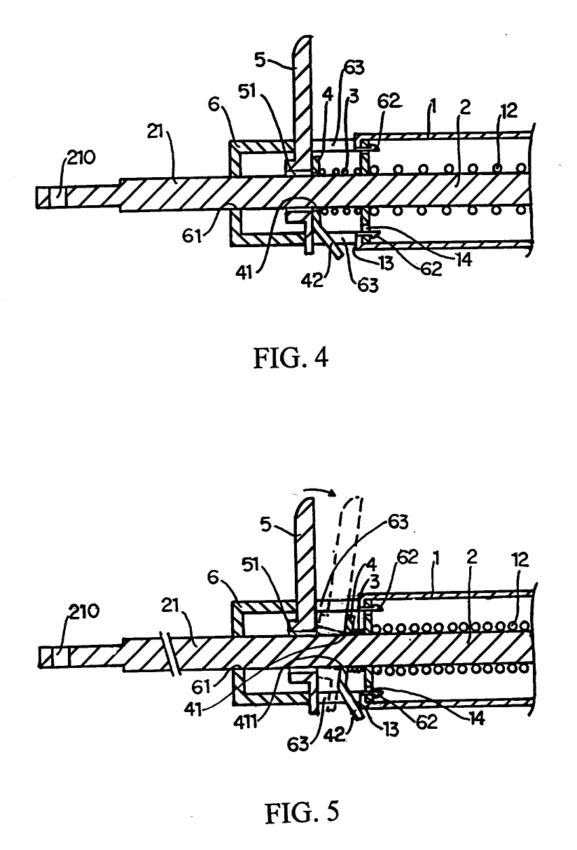

Referring to FIGS. 3 and 4, a door closer in accordance with the present invention generally comprises a cylinder 1 of a conventional design. The cylinder 1 includes holes 10 in an end thereof. Fasteners 11 extend through the holes 10 to fix the end of the cylinder 1 to a doorframe (not shown). A piston rod 2 is mounted in the cylinder 1 and includes an end extending beyond the other end of the cylinder 1. The exposed section 21 of the piston rod 2 includes a hole 210. A fastener 211 extends through the hole 210 of the piston rod 2 to fix the end of the piston rod 2 to a door (not shown). The length of the exposed section 21 in the closed state of the door is longer than that in the open state of the door. A compression spring 11 mounted in the cylinder 1 is compressed when the door is opened, and the spring force of the compression spring 11 automatically closes the door when the force for opening the door vanishes.

In a case that the door is to be retained in a desired open position so that the door would not be closed automatically, an elastic element 3, a retainer plate 4, a switch rod 5, and an end cap 6 are mounted around the exposed section 21 of the piston rod 2 in sequence.

The elastic element 3 may be a compression spring such that the elastic element 3 stores energy when it is compressed, and the stored energy allows the compressed element 3 to return its original shape. The elastic element 3 is mounted around the exposed section 21 of the piston rod 2 with an end of the elastic element 3 being attached to the cylinder 1 and with the other end of the elastic element 3 being attached to a side of the retainer plate 4. Thus, when not subject to an external force, the retainer plate 4 is biased by the elastic element 3 and thus disengaged from the cylinder 1.

As illustrated in FIG. 4, the switch rod 5 is attached to the other side of the retainer plate 4. The retainer plate 4 is identical to the conventional retainer plate 3′ and includes a central hole 41 through which the exposed section 21 of the piston rod 2 extends. An arrestor 42 projects from a lower side of the retainer plate 4 toward the cylinder 1. A lower end of the arrestor 42 slightly projects beyond a peripheral edge 13 of the cylinder 1. Thus, when the peripheral edge 13 of the cylinder 1 abuts against a side of the arrestor 42, the retainer plate 4 inclines at an angle such that an inner periphery 411 defining the central hole 41 of the retainer plate 4 arrests the moving piston rod 2, thereby stopping the piston rod 2 in a predetermined position, as shown in FIG. 5.

The switch rod 5 includes a hole 51 through which the exposed section 21 of the piston rod 2 extends. Since a side of the switch rod 5 is in contact with the retainer plate 4, the switch rod 5 can be moved to make the retainer plate 4 contact the peripheral edge 13 of the cylinder 1.

The end cap 6 includes a central hole 61 through which the exposed section 21 extends. At least one hook 62 is formed on a side of the end cap 6 for engaging with at least one hole 14 in the cylinder 1 adjacent to the peripheral edge 13, thereby enclosing the elastic element 3, the retainer plate 4, and the switch rod 5. Plural longitudinal slots 63 are defined in the periphery of the end cap 6 and have widths corresponding to those of the switch rod 5 and the retainer plate 4. Thus, the switch rod 5 and the arrestor 42 of the retainer plate 4 respectively extend through the longitudinal slots 63. The longitudinal slots 63 guide rectilinear movement of the switch rod 5 and the arrestor 42 of the retainer plate 4.

Referring to FIG. 5, when the force for opening the door vanishes, the returning force of the elastic element 12 automatically, gradually closes the door (the piston rod 2 is retracting). The switch rod 5 urges the retainer plate 4 to be in contact with the peripheral edge 13 of the cylinder 1. Thus, the peripheral edge 13 of the cylinder 1 presses against a side of the arrestor 42 of the retainer plate 4. As a result, the retainer plate 4 inclines at an angle. The inner periphery 411 defining the central hole 41 of the retainer plate 4 arrests the moving piston rod 2. Thus, the piston rod 2 is stopped in a predetermined position. Namely, the door is kept open at an angle. When automatic closing of the door is required, an external force is applied (the piston rod 2 is outreaching) to open the door such that the retainer plate 4 is disengaged from the peripheral edge 13 of the cylinder 1 under the action of the elastic element 3. When the force opening the door vanishes, the returning force of the elastic element 12 automatically, gradually closes the door.

In accordance with the door closer of the present invention, the widths of the longitudinal slots 63 respectively correspond to those of the switch rod 5 and the retainer plate 4 to allow extending of the switch rod 5 and the arrestor 42. Thus, the switch rod 5 and the arrestor 42 of the retainer plate 4 move rectilinearly along the longitudinal slots 63. The door is thus reliably retained 8 in a desired open position. Further, injury to the user is avoided, as the retainer plate 4 is enclosed by the end cap 6.

Although the invention has been explained in relation to its preferred embodiment, it is to be understood that many other possible modifications and variations can be made without departing from the scope of the invention as hereinafter claimed.

What is claimed is:

1. A door closer comprising:
a cylinder having an end;
a piston rod mounted in the cylinder and having an end extending beyond the end of the cylinder, the piston rod having an exposed section outside the cylinder;
a retainer plate mounted around the exposed section of the piston rod, the retainer plate including an arrestor projecting therefrom;
an elastic element mounted around the exposed section of the piston rod and including a first end attached to the end of the cylinder and a second end attached to a side of the retainer plate;
a switch rod mounted around the exposed section of the piston rod and including a first side in contact with another side of the retainer plate, the switch rod further including a second side; and
an end cap mounted around the exposed section of the piston rod and attached to the second side of the switch rod for enclosing the switch rod and the retainer plate, the end cap including two longitudinal slots through which the retainer rod and the arrestor of the retainer plate extend outward such that the retainer rod and the arrestor of the retainer plate are rectilinearly movable along the longitudinal slots.

2. The door closer as claimed in claim 1, wherein the end cap includes at lease one hook, the cylinder including at least one hole adjacent to the peripheral edge, said at least one hook being engaged in said at least one hole of the cylinder.
